(19) United States
(12) Patent Application Publication
(10) Pub. No.: US 2011/0059218 A1
(43) Pub. Date: Mar. 10, 2011

(54) SWEETENER, METHODS OF PREPARING SWEETENER AND APPLICATIONS THEREOF

(75) Inventors: Glenn A. Corliss, Bloomington, MN (US); Melanie J. Goulson, Dayton, MN (US); Brian D. Guthrie, Chanhassen, MN (US); Chin Hong Paul Kim, Plymouth, MN (US); John Thomas McDonald, Edina, MN (US); Drew Pecore, Maple Grove, MN (US); Troy Allen Rhonemus, Plymouth, MN (US); Thomas A. Sheehan, Cincinnati, OH (US); Norris Sun, Plymouth, MN (US); Carrie Michelle Thomas, Springdale, OH (US); Nese Yurttas, Shoreview, MN (US)

(73) Assignee: CARGILL INCORPORATED, Wayzata, MN (US)

(21) Appl. No.: 12/991,851

(22) PCT Filed: May 11, 2009
(86) PCT No.: PCT/US09/43479

§ 371 Date: Nov. 9, 2010

Related U.S. Application Data
(60) Provisional application No. 61/127,124, filed on May 9, 2008.

(51) Int. Cl. A23L 1/236

(52) U.S. Cl. 426/534; 426/548

(57) ABSTRACT

This disclosure pertains to a sweetener containing a high intensity sweetener and a taste modifying composition. In another aspect of the invention is a sweetener containing a high intensity sweetener, a taste modifying composition and a bulking material. Also disclosed are methods of making a sweetener of the present invention and methods of using the sweetener.

### CROSS REFERENCE TO RELATED APPLICATION

This application claims the benefit of U.S. provisional application Ser. No. 61/127,124 filed May 9, 2008 entitled SWEETENER. METHODS OF PREPARING SWEETENER AND APPLICATIONS THEREOF, which is hereby incorporated by reference.

### FIELD

The invention relates to sweeteners containing a high intensity sweetener and a taste modifying composition. The invention further relates to methods for making and using the sweeteners. The invention also relates to sweeteners containing a high intensity sweetener, a taste modifying composition and a bulking agent as well as methods for making and using the sweeteners.

### BACKGROUND

Consumers often add ingredients to foods they consume, customizing those foods to their personal taste preferences. For instance, consumers commonly add sugar in the form of sucrose (table sugar), crystalline glucose, trehalose, dextrose or fructose, for example, to beverages, such as, coffees and teas, on cereals, on fruits, and as toppings on baked goods to increase the sweet quality of the beverage or food item. Sugar generally consists of a class of edible crystalline substances including sucrose, lactose, and fructose. Human taste buds interpret its flavor as sweet. Sugar as a basic food carbohydrate primarily comes from sugar cane and from sugar beet, but also appears in fruit, honey, sorghum, sugar maple (in maple syrup), and in many other sources.

An alternative to sugar is high intensity sweeteners (also referred to herein as “HIS”). HIS such as aspartame, sucralose, stevioside, saccharin sodium, thaumatin, glycyrrhizin, acesulfame-K and sodium cyclamate, for example, are several times as sweet as sucrose, are often non-cariogenic and are either low-caloric or non-caloric. These HIS, or sugar substitutes, however, possess taste characteristics different than sugar, including, in some instances, undesirable taste characteristics such as sweetness linger, delayed sweetness onset, and non-sugar like aftertastes.

Because of these taste characteristics, use of HIS to replace sugar in a food or beverage has been limited. Attempts have been made to modify the taste profile of HIS to impart more sugar-like taste characteristics. For instance, products have been proposed that combine HIS with one or more bulking ingredients to dilute the intensity of the HIS. In some cases, the bulking agents are even described as having taste modifying properties that provide a more sugar-like taste and uniform sweetness. These products fail, however, to truly deliver on these attributes. Thus, there is still a need to provide a sweetener having a more sugar-like taste that includes a HIS. There is an additional need to provide a tabletop sweetener composition that includes a HIS having a more sugar-like taste.

### SUMMARY

This disclosure pertains to a sweetener containing a high intensity sweetener and a taste modifying composition. In one aspect the taste modifying composition includes at least one congruent flavor volatile, at least one non-congruent flavor volatile or a combination of at least one congruent flavor volatile and at least one non-congruent flavor volatile.

This disclosure also pertains to a sweetener containing a high intensity sweetener, a taste modifying composition and a bulking material.

Also disclosed are methods of making a sweetener of the present invention.

The resulting sweetener of the present invention may be used to create a variety of food, beverage, pharmaceutical and other products. In one embodiment, the sweetener is used in a tabletop sweetener.

The foregoing and other objects and features of the disclosure will become more apparent from the following detailed description.

### DETAILED DESCRIPTION

### I. Introduction

To better understand the present invention, it is useful to have at least a general knowledge of certain concepts and terminology related to taste and taste modification. First, taste is often referred to as a taste quality, which is selected from bitter, sweet, sour, salty and umami. It is possible to have one or more of these taste qualities within the same item. Taste modification often involves either an enhancement or synergy, or a suppression or masking of a particular taste quality. Taste modification may also involve a change in the duration (or time) and intensity of the taste quality. Thus, in a visual sense, a curve of a taste profile can be shifted forward or backward in time, be lengthened or shortened (duration) and certain peaks can be decreased or increased in height (intensity).

Furthermore, the senses of taste and smell (or odor) are anatomically two separate entities. Taste is stimulated through physical interactions of non-volatile molecules with receptors on the tongue and mouth surfaces, while volatile compounds reaching the receptors in the olfactory epithelium determine smell. At a perceptual level, however, there are many indications that the sensations of taste and smell, interact. Interactions may also occur with the other modalities of appearance, sound and texture.

The multimodal interaction and integration of these sensations results in a complex perception that is commonly called “flavor” or “taste.” Thus, unless a person is aguesic (those who perceive no tastes) or anosmic (those who cannot perceive odors), the consumption of foods and beverages results in the simultaneous perception of taste and smell, for example, which contributes to an overall impression of flavor. These perceptions are thought to be associated and interactive at the cognitive level (i.e. associative learning and integration) of the brain.

Studies have shown that the intensity of perceived flavors or tastes can be modified by simultaneous consumption with non-volatile molecules and volatile compounds when there is a logical association between them, called congruency, such as between sweetness via a non-volatile molecule and fruitiness via a volatile compound. For example, in a real food context, strawberry odor enhances whipped cream sweetness. Moreover, vanilla flavoring enhances sweetness perceived by humans when added to milk. Thus, the volatile compound, in this case a congruent flavor volatile, works synergistically with the non-volatile molecules to enhance (or increase) the perception of sweetness. Other examples of taste enhancement by congruent volatile compounds include the use of citral (lemon-like), ethyl butyrate, benzaldehyde, and pineapple flavoring enhancement of sweetness as well as peach aroma enhancement of sweetness intensity and duration.

Studies have also reported that an odor can suppress perceived flavor intensity when the taste-odor pair is not congruent (or non-congruent). For instance, experiments with caramel odor, which is related to sweet taste, demonstrated a suppression of sour taste intensity and peanut butter odor suppressed whipped cream sweetness. No studies have been focused on the taste modifying effects (e.g. enhancement, synergy, suppression, masking) of mixtures of congruent flavor volatiles, however, and non-congruent flavor volatiles and reports of non-congruent flavor volatile enhancement of taste are extremely rare.

The present invention reports taste modifying compositions containing certain congruent flavor volatiles that can be used for taste modification of certain ingredients. For example, in one embodiment, a sweetener is provided that includes a HIS and a taste modifying composition having at least one congruent flavor volatile to enhance sweet quality of the HIS. Surprisingly, the inventors have also identified a taste modifying composition containing at least one non-congruent flavor volatile that can also be used to enhance sweet quality of a HIS. Thus, in another embodiment a sweetener is provided that includes a HIS and a taste modifying composition containing at least one non-congruent flavor volatile to enhance sweet quality of the HIS. In another aspect, the non-congruent flavor volatile may actually perform a dual function in that it both enhances sweet quality of the HIS and also masks the bitter quality of the HIS. In yet another embodiment is provided a sweetener having a HIS and a taste modifying composition containing at least one non-congruent flavor volatile and at least one congruent flavor volatile to enhance sweet quality of the HIS.

### II. Abbreviations and Terms

The following explanations of terms and methods are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Definitions of common terms in chemistry may be found in Richard J. Lewis, Sr. (ed.), Hawley's Condensed Chemical Dictionary, published by John. Wiley & Sons, Inc., 1997 (ISBN 0-471-29205-2).

Explanations of certain specific terms are generally provided within the text of the application.

### III. The Sweetener

In one embodiment of the present invention, a sweetener is provided that includes a HIS and a taste modifying composition. In one aspect of the present invention, the weight ratio on a dry basis of the HIS to the taste modifying composition is from about 0.0010:1 to about 1000:1. In another aspect of the present invention, the weight ratio on a dry basis of the HIS to the taste modifying composition is from about 0.01:1 to about 286:1. In yet another aspect of the present invention, the weight ratio on a dry basis of the HIS to the taste modifying composition is from about 1.8:1 to about 115:1.

In another embodiment of the present invention, a sweetener is provided that includes a bulking material, a HIS and a taste modifying composition. In one aspect of the present invention, the weight ratio on a dry basis of the bulking material to the HIS to the taste modifying composition is from about 0.0010:0.1:1 to about 1000:100,000:1. In another aspect of the present invention, the weight ratio on a dry basis of the bulking material to the HIS to the taste modifying composition is from about 225:1.80:1 to about 14,370:115:1. In still another embodiment, the sweetener may include optional ingredients such as for example, characterizing flavors and colors. Alternatively, optional ingredients may be added to the taste modifying composition. It is also possible that optional ingredients may be added to both the sweetener and the taste modifying composition. Such optional ingredients generally are known to those of skill in the art and may include, for instance, coloring agents, carriers, flavor compounds and the like. For instance, the taste modifying composition may include a strawberry flavor compound to provide a sweetener capable of delivering not only a sweet flavor but also a strawberry flavor. This could then be incorporated into a strawberry yogurt product to increase the perception of strawberry flavor compared to a yogurt product without the taste modifying composition. Alternatively, the sweetener may he colored to a golden brown color to simulate the appearance of raw sugar. Other optional ingredients may include certain carriers and inactive ingredients. These carriers and inactive ingredients may merely facilitate processing of the sweetener. Additionally, a flow agent or anti-caking agent such as tricalcium phosphate may be added to improve flowability of a tabletop sweetener.

The sweetener may take many forms including, but not limited to, a crystal, a powder, a tablet, a liquid, a cube, a glaze or coating, a granulated product, or combinations thereof.

In some cases, such as for use as a table-top sweetener, it may be desirable to provide the sweetener in the form of a crystal that has an appearance comparable to that of sucrose crystals, e.g., to improve end user acceptance of the sweetener compositions. It may also be desirable to provide the sweetener in the form of a crystal that has similar solubility profile to sucrose, which becomes apparent, e.g., when the sweetener is mixed into an unsweetened beverage.

Where the sweetener is not formulated to mimic the appearance or solubility characteristics of sucrose, is may be formulated to minimize volume, maximize solubility, maximize stability, or otherwise improve product handling and distribution.

One form of the sweetener may be an admixture. The sweetener may also be provided in the form of coated granules in which one or more first component of the sweetener composition is coated over one or more second component of the sweetener composition. For example, the taste modifying composition may be coated onto granules, crystals, or other forms of a HIS, such that taste buds are first exposed to the taste modifying composition, and then to the HIS. In this manner, the taste buds are modified by the taste modifying composition in preparation for exposure to the HIS. In another example, the HIS may be coated onto granules, crystals, or other forms of the taste modifying composition, such that taste buds are first exposed to the HIS, followed by exposure to the taste modifying composition, which alters the perceived sweetness of the HIS. This arrangement allows the taste modifying composition to potentially mask a bitter aftertaste associated with a HIS while minimally affecting its initial perception of sweetness. In yet another example, the HIS and taste modifying composition may be coated onto granules, crystals, or other forms of a bulking material, such that taste buds are first exposed to the HIS and taste modifying composition, followed by exposure to the bulking material.

a. High Intensity Sweeteners (HIS)

As used herein the phrase high intensity sweetener (HIS) means, generally, any sweetener which may be in raw, extracted, purified, or any other form, singularly or in combination thereof and characteristically have a sweetness potency greater than sucrose (common table sugar) yet have comparatively less calories. Even if the HIS has the same number of calories as sucrose, the usage amount of HIS is considerably less than sucrose thereby reducing the total calorie amount. For instance, because HIS are compounds having a sweetness that is many times that of sucrose, much less HIS is required to obtain a similar effect as sucrose and energy contribution is therefore negligible.

Non-limiting examples of HIS suitable for embodiments of the present invention include rebaudioside A, rebaudioside B, rebauclioside C, rebauclioside D, rebaudioside E, rebaudioside F, dulcoside A, dulcoside B, rubusoside, stevia, stevioside, mogroside IV, and mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside 1, periandrin I, abrusoside A, and cyclocarioside I. HIS also include modified HIS. Modified HIS include HIS which have been altered naturally. For example, a modified HIS includes, but is not limited to, HIS which have been fermented, contacted with enzyme, or derivatized or substituted on the HIS.

In another embodiment, the HIS may be selected from the group consisting of rebaudioside A, rebaudioside B, rebaudioside C, rebaudioside D, rebaudioside E, rebaudioside F, dulcoside A, dulcoside B, rubusoside, stevia, stevioside, mogroside IV, mogroside V, Luo Han Quo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, saccharin and its salts, cyclamic acid and its salts, aspartame, aspartame-acesulfame salt, acesulfame potassium, sucralose, alitame, neotame, neohesperidin dihydrochalone (NHDC), advantame and combinations thereof.

Steviol glycosides refer collectively to the terpene glycosides responsible for the sweet taste of the leaves of the stevia plant, a shrub in the chrysanthemum family native to Paraguay. Stevia rebaudiana is best know for its sweetness, although the genus includes other members (e.g., S. eupatoria, S. ovata, S plummerae, S. salicifolia, and S. serrata), which may also produce sweet tasting glycosides. Stevia products have been used as sweeteners throughout the world for decades. Particular stevia compounds range in sweetness from about 40 to about 300 times that of sucrose, are heat and pH stable, do not ferment, and do not induce a glycemic response when ingested by mammals. Some of these latter features make them attractive for use as natural sweeteners for diabetics and other people on carbohydrate-controlled diets.

Major steviol glycosides and their approximate relative amounts found in S. rebaudiana include stevioside (5-10%), rebaudioside A (2-4%), rebaudioside C (1-2%), and dulcoside A (0.5-1%), as well as rebaudioside B, rebaudioside D, rebaudioside E, rebaudioside F, dulcoside B, and rubusoside. Many of these steviol glycosides, whether isolated from stevia plants, isolated from other plants, or chemically synthesized, can be used as a HIS.

In one embodiment, extracts of HIS may be used in any purity percentage. In another embodiment, when a HIS is used as a non-extract, the purity of the HIS may range for example from about 25% to about 100%. In another example, the purity of the HIS may range from about 70% to about 100%; from about 80% to about 90%; from about 90% to about 100%; from about 95% to about 100%; from about 96% to about 99%; from about 97% to about 98%; from about 98% to about 99%; and from about 99% to about 100%. Purity as used herein refers to a purity of a single type of HIS.

Purity, as used here, represents the weight percentage of a respective HIS compound present in a HIS extract, in raw or purified form. In one embodiment, a steviol glycoside extract comprises a particular steviol glycoside in a particular purity, with the remainder of the steviol glycoside extract comprising a mixture of other steviol glycosides.

To obtain a particularly pure extract of a HIS, such as rebaudioside A, it may be necessary to purify the crude extract to a substantially pure form. Such methods generally are known to those of ordinary skill in the art. An exemplary method for purifying a HIS such as rebaudioside A, is describes in U.S. provisional patent application Nos. 60/881,798 and 61/008,163, the disclosures of which are incorporated herein by reference in their entirety.

A steviol glycoside of particular interest is rebaudioside A. Rebaudioside A is comparatively sweeter and less bitter than other steviol glycosides. It further has a sweetness that it several hundred times that of sucrose. Thus, in one embodiment of the present invention the HIS is rebaudioside A in a purity greater than about 97% rebaudioside A by weight on a dry basis. In another embodiment of the present invention, the HIS is rebaudioside A in a purity greater than about 90% rebaudioside A by weight on a dry basis. In still another embodiment, the HIS is rebaudioside A in a purity greater than about 80% rebaudioside A by weight on a dry basis.

The Lo Han Kuo (also known as Lo Han Guo) fruit (Siraitia grosvenori) is another plant containing terpene glycosides that have been used as sweeteners. Among these compounds are mogrosides I, mogrosides II, mogrosides III, mogrosides IV (esgoside), mogrosides V, siamenoside, and neomogroside. Collectively, these compounds are about 300 times as sweet as sucrose, although individual compounds are even sweeter.

The high intensity sweetener may also be a non-saccharide artificial sweetener, such as aspartame, sucralose, saccharin and its salts, cyclamic acid and its salts, alitame, neotame, NHDC, aspartame-acesulfame salt, advantame and acesulfame potassium. Such sweeteners are non-caloric or low-caloric at levels used to adequately sweeten food (because they are so potent) their caloric amount is negligible, making them well suited for food products targeted at diabetics and people and animals on controlled carbohydrate diets. Other high intensity sweeteners included but are not limited to monatin and its salts (i.e., monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, and combinations thereof.

The particular HIS (or combination of HIS) selected for combination with the taste modifying composition depends on the characteristics desired in the resulting sweetener. Where a “natural,” sweetener is desired, possible HIS plant glycosides and other compounds that occur in nature and have a sweet quality with or without caloric value. The plant glycosides also address situations where caloric content and fermentability are an issue. Where a non-natural HIS can be used, aspartame, saccharin, or other synthetic sweeteners may be used.

In one embodiment of the present invention, the taste modifying composition is itself a natural product, therefore combining a naturally-occurring HIS with a natural taste modifying composition produces a sweetener that includes only naturally-occurring components, (i.e., an “all natural product”) which is a feature that many end users find attractive.

While the use of some nutritive HIS (such as a saccharide) produces a sweetener that has caloric value, the sweetness enhancement made possible using the taste modifying composition means that a smaller quantity of the HIS is required to a produce the same perception of sweetness. Thus, a sweetener containing a nutritive HIS in combination with a taste modifying composition of the present invention will have fewer calories per serving than the HIS, alone, providing a “low calorie” product based on a palatable caloric sweetener, such as sucrose, glucose, fructose (including HFCS), and the like.

HIS for use in the present invention may have characteristics that make them undesirable for use on its (their) own, however, such characteristics may be masked, eliminated, or off-set by a taste modifying composition. For example, the HIS may have a bitter taste or aftertaste, a sweetness that is slower, or a sweetness that is different in duration than known palatable sweeteners, such as sucrose. The HIS may also have a sweet quality that is slower in intensity and longer in duration compared to sweet quality of sugar. In one instance, the at least one congruent flavor volatile may enhance sweet quality of the HIS while the at least one non-congruent flavor volatile masks bitter quality of the HIS thereby providing a perception of increased sweet quality. In another instance, the taste modifying composition may modify the sweet quality duration of the high intensity sweetener such that the sweet quality intensity occurs earlier compared to a composition of the HIS alone. In one aspect, this may provide an increased perception of sweet quality. Alternatively, the taste modifying composition may modify sweet quality duration of the HIS such that the sweet quality intensity diminishes earlier compared to a composition of the HIS sweetener alone. In one aspect, this may help reduce the perception of a licorice, metallic, lingering off-taste or bitterness for example. In yet another aspect, the HIS may have a sweet quality that is slower in onset and longer in duration than the sweet quality of sugar but a taste modifying composition containing at least one congruent flavor volatile and at least one non-congruent flavor volatile modify the sweet quality of the HIS such that the sweet quality intensity occurs earlier and the sweet quality diminishes earlier compared to a composition of the HIS alone.

b. Taste Modifying Composition

In addition to a HIS, the sweetener of the present invention further includes a taste modifying composition to alter the flavor quality of the sweetener. Where present, such taste modifying compositions may further increase, or decrease, the sweet flavor quality onset (also referred to as sweetness onset), duration or intensity of the HIS, compared to a composition of the HIS alone.

The taste modifying composition may include at least one congruent flavor volatile, at least one non-congruent flavor volatile or a combination of both at least one congruent flavor volatile and at least one non-congruent flavor volatile. Congruent flavor volatiles of the present invention are generally compounds found in combination with sweet compounds, and to which animals develop a cognitive association with the sweet compounds, through stimulus experience (see, e.g., Small et al. (2007) Ann. N.Y. Acad. Sci. 1121:136-151). Congruent flavor volatiles thus may impart a sweet or fruity flavor quality. Non-congruent flavor volatiles in contrast are not typically subject to such perceptions.

In one aspect, the taste modifying composition contains at least one congruent flavor volatile. In this aspect the at least one congruent flavor volatile enhances sweet quality of the high intensity sweetener, and therefore the sweetener, compared to the sweet quality of the high intensity sweetener alone. In another aspect, the taste modifying composition contains at least one non-congruent flavor volatile. In this aspect the at least one non-congruent flavor volatile enhances sweet quality of the high intensity sweetener, and therefore the sweetener, compared to the sweet quality of the high intensity sweetener alone. In yet another aspect, the taste modifying composition contains at least one non-congruent flavor volatile and at least one congruent flavor volatile. In this aspect, the at least one congruent flavor volatile and at least one non-congruent flavor volatile enhance sweet quality of the high intensity sweetener, and therefore the sweetener, compared to the sweet quality of the high intensity sweetener alone. In still another aspect, the taste modifying composition contains at least one non-congruent flavor volatile and a plurality of congruent flavor volatiles. In this aspect, the at least one non-congruent flavor volatile and the plurality of congruent flavor volatiles enhance sweet quality of the high intensity sweetener, and therefore the sweetener, compared to the sweet quality of the high intensity sweetener alone.

The present invention reports taste modifying compositions containing certain congruent flavor volatiles that can be used for taste modification of certain ingredients. For example, in one embodiment, a sweetener is provided that includes a high intensity sweetener and a taste modifying composition having at least one congruent flavor volatile to enhance sweet quality of the sweetener. Surprisingly, the inventors have also identified a taste modifying composition containing certain non-congruent flavor volatiles that can indeed be used to enhance sweet quality of a high intensity sweetener. Thus, in another embodiment a sweetener is provided that includes a high intensity sweetener and a taste modifying composition containing at least one non-congruent flavor volatile to enhance sweet quality of the sweetener. In yet another embodiment is provided a sweetener having a high intensity sweetener and a taste modifying composition containing at least one non-congruent flavor volatile and at least one congruent flavor volatile to enhance sweet quality of the sweetener. In still another aspect is a taste modifying composition containing a plurality of congruent flavor volatiles.

Without intending to be bound by any theory it is believed that non-congruent flavor volatiles alter the neurological taste bud signaling that occurs in the presence of a HIS, thereby improving the perceived taste of the HIS. Non-congruent flavor volatiles may function, at least in part, by decreasing, or masking, the perceived bitterness of the HIS, thereby enhancing the perceived sweetness of the HIS. Examples of non-congruent flavor volatiles include alpha ionone, allyl alpha-ionone, cycloionone, dehydrodihydroionone, dihydro-alpha-ionone, dihydro-beta-ionone, dihydromethyl-alpha-ionone, dimethylionone, (E)-6,10-dimethylundeca-5,9-dien-2-one, gamma ionone, gamma-methyl ionone, ionone, alpha-ionone, β-ionone, trans-beta-ionone, beta-ionone epoxide, gamma-ionone, alpha-ionone, isobutylionone, alpha-isomethylionone, beta-isomethylionone, methylionone, methyl-alpha-ionone, alpha-methyl-ionone, methyl-beta-ionone, methyl-delta-ionone, methyl alpha-iononylglycidate, beta-methylionone diethyl ketal, methylisopseudoionone, pseudomethylionones, 3,4,5,6-tetrahydropseudoionone, pseudoionone raspberry essence, raspberry seed extract, jasmine absolute, and boronia absolute. Thus, in one embodiment of the present invention, the at least one non-congruent flavor volatile is, alpha ionone, allyl alpha-ionone, cycloionone, dehydrodihydroionone, dihydro-alpha-ionone, dihydro-beta-ionone, dihydromethyl-alpha-ionone, dimethylionone, (E)-6,10-dimethylundeca-5,9-dien-2-one, gamma ionone, gamma-methyl ionone, ionone, alpha-ionone, β-ionone trans-beta-ionone, beta-ionone epoxide, gamma-ionone, alpha-irone, isobutylionone, alpha-isomethylionone, beta-isomethylionone, methylionone, methyl-alpha-ionone, alpha-methyl-ionone, methyl-beta-ionone, methyl-delta-ionone, methyl alpha-iononylglycidate, beta-methylionone diethyl ketal, methylisopseudoionone, pseudomethylionones, 3,4,5,6-tetrahydropseudoionone, pseudoionone raspberry essence, raspberry seed extract, jasmine absolute, boronia absolute and combinations thereof.

As described above, Non-congruent flavor volatiles may be combined with HIS in a physically-combined form, such as an admixture, or a coated formulation that controls the order in which the components of the sweetener compositions contact the taste buds. Coated formulations are most effective when the sweetener composition is present in dry form, for example, in a baked good, candy bar, or the like, as opposed to being dissolved in a liquid.

Congruent flavor volatiles would generally be known to one of ordinary skill in the art. Some specific examples of congruent flavor volatiles may include vanillin, vanilla extract, divanillin, ethyl vanillin, ethylvanillin acetate, ethylvanillin beta-d-glucopyranoside, ethylvanillin isobutyrate, ethylvanillin propylene glycol acetal, vanillin acetate, vanillin erythro and threo butan-2,3-dial acetal, vanillin isobutyrate, vanillin 3-(1-menthoxy)propane-1,2-diol acetal, vanillin propylene glycol acetal, veratraldehyde, 3-Ethyl-2-hydroxy-4-methylcyclopent-2-en-1-one, 5-Ethyl-2-hydroxy-3-methylcyclopent-2-en-1-one, methylcyclopentenolone, ethyl cyclopentenolone, ethyl maltol, maltol, maltol acetate, maltol butyrate, maltol isobutyrate, maltol propionate, sugar treattarone, sugar distillate, molasses distillate, malt distillate, 4-hydroxy-5-methyl-3(2H)furanone, 4-acetoxy-2,5-dimethyl-3 (2H)-furfanone, caramel furfanone, 4,5-dimethyl-3-hydroxy-2,5-dihydrofuranone (Sotolone), 4-hydroxy-2,5-dimethyl-3(2H)furanone (Strawberry Furanone), 2-ethyl-4-hydroxy-5-methyl-3(2H)furanone (Homofuronol), 5-methly furfural, 4-methyl-1-phenyl-2-pentanone, Isobutyl benzyl ketone, 2-Methyltetrandrofuran-3-one, coffee furanone, 2-Oxobutyric acid, maltone, valeraldehydes, butyraldehydes, phenyl compounds, such as phenyl acetaldehyde, beeswax absolute, honey distillate, and rum absolute. The usage level of each flavor volatile, where the taste modification composition includes more than one flavor volatile will depend to a certain extent on the HIS.

The sweetener may further comprise certain inactive ingredients such as water, propylene glycol, ethyl alcohol, glycerol and combinations thereof.

c. Bulking Material

The sweetener may further include one or more bulking materials. In one aspect of the present invention, the bulking material may add bulk to the sweetener thereby making a single serving of the present compositions more similar to that of sucrose. End users of a sweetener may also find it easier to control the amount of sweetener added to a food or beverage, particularly when the serving size is similar to a known sweetener. Bulking materials may also contribute to body, viscosity, and other aspects of mouth-feel in liquids; volume, cell structure, crumb structure, and humectancy in baked goods; control over the freezing and melting points of foods and beverages; and overall visual and textural impressions of foods and beverages that include the present sweetener. In a further aspect, the bulking material itself may contribute to an increased sweet quality of the HIS. In another aspect, the bulking material is low to non-caloric and may provide less than about 0.2 calories per gram of bulking agent.

In still another aspect of the present invention, the bulking material has a uniform crystalline structure, i.e. narrow particle size distribution. The uniform crystalline structure may provide for greater control over the ratio of bulking material to HIS to taste modifying composition. In one embodiment of the present invention, the bulking material has a size of from about 0.125 mm to about 1.0 mm. In another embodiment of the present invention, the bulking material has a size of from about 0.21 mm to about 0.71 mm. In still another embodiment of the present invention, the bulking material has a size of from about 0.25 mm to about 0.60 mm.

In yet another aspect of the present invention, the bulking agent has a solubility profile that is slower than either the HIS or taste modifying composition. Thus, if the HIS and taste modifying composition were to be deposited onto an bulking agent to form a tabletop sweetener product, the tabletop sweetener product may actually perform more like sugar when introduced into a beverage, particularly a cold beverage, where the granules do not immediately dissolve.

Exemplary bulking materials may be selected from the group consisting of maltodextrin, corn syrup solids, sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, trehalose, isomaltulose, arabinogalactan, gum Arabic, gum tragacanth, guar gum and hydrolyzed guar gum, and mixtures thereof. It may also be possible to utilize certain starches and modified starches.

In one embodiment of the present invention, the bulking material is erythritol. In another embodiment, the bulking material is glycerol or propylene glycol. These particular bulking materials are available in a liquid form, which may provide for a liquid tabletop sweetener preparation.

### IV. Methods of Preparing the Sweetener and Related Products

The present invention further includes methods of preparing the sweetener and related products. In one embodiment, the sweetener of the present invention is prepared by dissolving a HIS and a taste modifying composition in water. The HIS and taste modifying composition may either be dissolved individually to form two aqueous solutions or in combination to form a single aqueous solution containing both the HIS and taste modifying composition. In the event that the HIS and taste modifying composition are dissolved in combination, the HIS and taste modifying composition may be added in any order, including simultaneously. In the event the HIS and taste modifying composition are dissolved individually, they may be later combined into a single, aqueous mixture. In one aspect of this embodiment, the temperature of the water is at room temperature. In another aspect, the temperature of the water is heated, such as for example to from about 10 to about 70 degrees Celsius. In still another aspect, the temperature of the water used for the HIS is heated while the temperature of the water used for the taste modifying composition is at room temperature. Where the taste modifying composition includes more than one component, such as for example, a plurality of congruent flavor volatiles and at least one non-congruent flavor volatile, the components may be delivered in a single fraction or in more than one fraction. For example, the components may be added using a powder fraction containing a blend of dry powdered components and a liquid fraction containing and blend of the remaining components that have been dissolved in an appropriate carrier solution such as water and ethanol. The sweetener can then be processed in a number of ways, such as for example, spray drying, to reduce the moisture level of the sweetener.

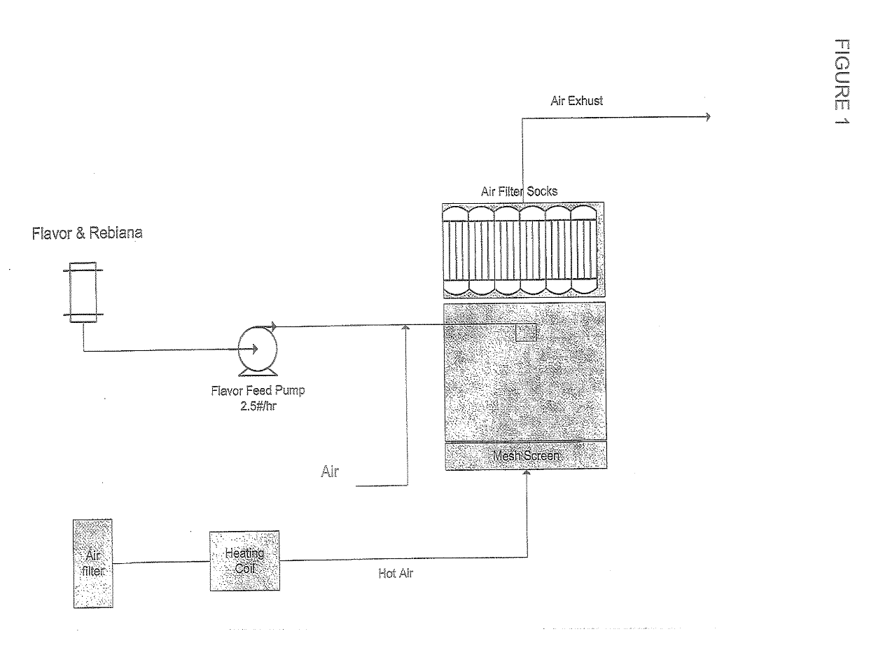

In another embodiment, is provided a method of preparing a tabletop sweetener. Generally, a HIS and a taste modifying composition are deposited onto a bulking material having a size distribution of from about 0.125 mm to about 1.0 mm. The HIS and taste modifying composition can be deposited in any order, including simultaneously. Methods to deposit the HIS and taste modifying composition will be generally known to one of skill in the art. FIG. 1 provides an illustration of just one possible method. As is illustrated in FIG. 1., the bulking material is placed in a coating vessel (positioned on the right side of the diagram) and air is blown through the vessel (from the bottom of the vessel through the top) in order to cause the bulking material to move about randomly inside of the vessel (i.e., the particles are fluidized). Next, a solution comprising HIS in water is introduced into the vessel and is allowed to deposit on the surface of the bulking material. Heated air is blown through the coating vessel in order to dry the HIS onto the bulking material. After coating the bulking material with HIS, the taste modifying composition is introduced into the coating vessel as a water-based solution. Similar to the HIS, the taste modifying composition deposits on the surface of the bulking material and is dried by blowing air through the coating vessel. In a particular aspect of the present invention, the air that is blown through the coating vessel is not heated. This may reduce thermal degradation of the taste modifying composition. The resulting tabletop sweetener composition includes a bulking material with HIS and a taste modifying composition deposited on its surface. The resulting tabletop sweetener may also be prepared by first introducing the taste modifying composition into the vessel and then introducing the HIS solution into the vessel. Alternatively, the HIS solution and liquid taste modifying composition may be added simultaneously into the vessel. In one embodiment, the HIS is rebaudioside A and the bulking material is erythritol. In another embodiment, the size distribution of the bulking material is such that the tabletop sweetener has a desired taste and serving-to-serving consistency. In particular, the size distribution of the bulking material is selected to provide tabletop sweetener particles that have the desired ratio of HIS to bulking material and HIS to taste modifying composition. Furthermore, the tabletop sweetener particle size is similar to sugar.

In still another embodiment, HIS is dissolved in room temperature water. A taste modifying composition, also at room temperature, is blended into the HIS-water mixture. A bulking material is added to an agglomeration unit where it is suspended by heated air. While suspended, the mixture of HIS, taste modifying composition and water is sprayed into the agglomeration unit in such a way as to allow the components to deposit onto the bulking material. By controlling the temperature in the agglomeration unit the water is removed and the moisture content of tabletop sweetener is comparable to the starting moisture of the bulking material.

In yet another embodiment, HIS is dissolved in heated water. In one aspect, the heated water increases the solubility of the HIS and therefore less water is necessary to fully dissolve the HIS. A bulking material is added to an agglomeration unit where it is suspended by heated air. While suspended, the mixture of HIS and water is sprayed into the agglomeration unit in such a way as to allow the components to deposit onto the bulking material. The HIS is then dried onto the bulking material using heated air. In one aspect, the air is heated to from about 20 to about 130 degrees Celsius. In another aspect, the air is heated to from about 60 to about 70 degrees Celsius. The bulking material deposited with HIS continues to be suspended by air only the temperature of the air is reduced. In one aspect the temperature of the air is reduced to ambient temperature. A mixture of a taste modifying composition and room temperature water is then introduced into the agglomeration unit in such a way as to allow the components to deposit onto the bulking material and HIS. By controlling the temperature in the agglomeration unit the water is removed to obtain final moisture content of the tabletop sweetener comparable to that of the starting moisture of the bulking material. In one aspect, the air temperature is from about 20 to about 130 degrees Celsius. In an embodiment, the method produces a tabletop sweetener in which the ratio on a dry weight basis of bulking material to HIS to taste modifying composition is from about 225:1.80:1 to about 14,370:115:1. In a further embodiment, the bulking material is erythritol and the HIS is rebaudioside A.

### V. Applications of the Sweetener

In one embodiment, a tabletop sweetener is provided that includes the sweetener of the present invention. Also provided are food and beverage products containing either the sweetener or a tabletop sweetener of the present invention. Exemplary foods and beverages include baked goods, chocolate, candy and confections, chewing gum, ice cream, yogurt, breakfast cereal, oatmeal, pudding, fruit preserves and preparations, breakfast bars, protein bars, granola bars, cereal coatings, syrups, marinades, ketchup, salad dressings, baby food, pet food, animal feed, soft drinks, fruit juices, coffee, tea, sport and energy drinks, and other foods and beverages. A particular class of beverages for which the present compositions and methods are useful is diet soft drinks (or sodas), such as colas, citrus and fruit flavored beverages, and the like. Additionally, pharmaceutical and over the counter drug products may contain either the sweetener or a tabletop sweetener of the present invention.

### VI. Examples

The following, non-limiting examples will more fully illustrate the embodiments of this invention. In these examples, all parts and percentages are given by dry weight basis and all temperatures are in degrees Celsius unless otherwise noted.

### Sensory Methods

Examples 1-4 set forth below discuss certain sensory evaluations. In conducting these sensory evaluations, the following methods were employed.

### Example 1

### Taste Test Involving HIS and Taste Modifying Composition

A consumer panel taste test was performed comparing aspartame to a first sample (Sample A) containing a HIS (where the HIS is rebaudioside A) and a bulking agent (where the bulking agent is erythritol) and to a second sample (Sample B) containing a HIS (where the HIS is rebaudioside A), a taste modifying composition (where the taste modifying composition contains only a non-congruent flavor volatile) and a bulking agent (where the bulking agent is erythritol). The aspartame was an EQUAL-brand table-top formulation.

Each tasting session is referred to as sensory analysis request (SAR) and assigned a number. The consumers were asked to rate the overall liking of three solutions: one containing aspartame, another containing Sample A and a third containing Sample B.

In rating the “overall liking”, the consumer panelists were asked to rate the sample on a scale of 1-9, in which 1=dislike extremely, 2=dislike very much, 3=dislike moderately, 4=dislike slightly, 5=neither like nor dislike, 6=like slightly, 7=like moderately, 8=like very much, 9=like extremely. The data was analyzed by ANOVA with SAS statistical program for significant differences in means between the samples. Results and analyses showing overall liking are presented in Table 1.

TABLE 1
Taste test results

| SAR 466 | | SAR 461 | | SAR 546 | |
|---|---|---|---|---|---|
| Samples | Overall* | Samples | Overall* | Samples | Overall* |
| (n = 90) | Liking | (n = 87) | Liking | (n = 63) | Liking |
| Aspartame | 6.67 | Aspartame | 6.23 a* | Aspartame | 6.52 |
| Sample A | 5.90 | Sample B | 6.20 a* | Sample B | 6.19 |

The results of the SAR 466 tasting session indicated that a sweetener composition containing the Sample A scored significantly lower than aspartame in overall liking when evaluated as a sweetening agent in FOLGERS instant coffee. In other words, the panelists preferred coffee sweetened with aspartame over coffee sweetened with Sample A.

The results of the SAR 461 and 546 tasting sessions indicated that a sweetener composition containing Sample B scored about the same (i.e. not statistically different) than aspartame in overall liking. In other words, panelists liked FOLGERS instant coffee sweetened with Sample B, and with aspartame, equally well.

### Example 2

### Taste Test Involving the Sample B in a Single Session

The taste test was similar to that described in Example I, except that the panelists evaluated different sweetener compositions in one session. The sweetener compositions were added to 4 oz. hot FOLGERS instant coffee, which was served at a temperature of 158-169° F. in an 8 oz styrofoam cup. The panelists were instructed to pre-rinse their palettes with sucrose-sweetened coffee (8 g sugar in 6 oz coffee) prior to tasting the coffee sweetened with the subject sweetening agent, and to and rinse with water five times and wait four minutes between tasting different beverages.

The panelists were asked to complete a questionnaire/ballot that used a standard 9-point hedonic scale involving: Bitterness/Sweetness JAR (Just About Right Scale), Bitterness/Aftertaste Intensity LMS (Labeled Magnitude Scale), and creamer usage. The data were analyzed by ANOVA using a SAS statistical program to determine significant differences in means between the samples. The results regarding specific attributes are shown in Tables 2-5.

TABLE 2
Description of taste samples used for SAR #461

| Sample ID | Description | Amount Used |
|---|---|---|
| Aspartame | Dextrose with maltodextrin, | 1.0 g/6 oz coffee* |
| (EQUAL) | aspartame | |
| Sample B | Rebaudioside A (0.032 g) + Taste | 4.0 g/6 oz coffee* |
| | modifying composition with non- | |
| | congruent flavor volatile (0.0246 | |
| | ppm) + erythritol (3.968 g) | |

*FOLGERS Instant coffee
n = 87

TABLE 3
SAR #461 results

| Samples | Overall** | Flavor** | Bitterness*** | Aftertaste*** |
|---|---|---|---|---|
| (n = 87) | Liking | Liking | Intensity | Intensity |
| Aspartame | 6.23 | 6.25 | 12.42 | 14.69 |
| (EQUAL) | | | | |
| Sample B | 6.20 | 6.10 | 14.23 | 16.73 |

**1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely
***0-100 scale; “barely detectable” = 1.4; “weak” = 6.1; “moderate” = 17.2; “strong” = 35.4; “very strong” = 53.3; “strongest imaginable” = 100

The results of the SAR #461 tasting session indicated that a sweetener composition containing Sample B scored about the same as aspartame in overall liking and flavor liking, and scored marginally higher than aspartame with respect to bitterness intensity and aftertaste intensity.

TABLE 4
Description of taste samples used for SAR #466

| Sample ID | Description | Amount Used |
|---|---|---|
| Aspartame | Dextrose with maltodextrin, | 1.0 g/6 oz coffee* |
| (EQUAL) | aspartame | |
| Sample A | Rebaudioside A (0.032 g) + | 4.0 g/6 oz coffee* |
| | erythritol (3.968 g) | |

*FOLGERS Instant coffee
n = 90

TABLE 5
SAR #466 results

| Samples | Overall** | Flavor** | Bitterness*** | Aftertaste*** |
|---|---|---|---|---|
| (n = 90) | Liking | Liking | Intensity | Intensity |
| Aspartame | 6.67 | 6.68 | 9.74 | 11.04 |
| (EQUAL) | | | | |
| Sample A | 5.90 | 5.87 | 13.85 | 16.10 |

*Means followed with different letters are significantly different from each other at p < 0.05
**1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely
***0-100 scale; “barely detectable” = 1.4; “weak” = 6.1; “moderate” = 17.2; “strong” = 35.4; “very strong” = 53.3; “strongest imaginable” = 10

The results of the SAR #466 tasting session indicated that a sweetener composition containing Sample A scored lower than aspartame in overall liking and flavor liking, and scored significantly higher than aspartame with respect to bitterness intensity and aftertaste intensity.

### Example 3

### Taste Test Involving Sample C Over Two Sessions

The taste test was similar to that described in Example 2, except that the panelists evaluated each of the two different sweetener compositions in a different session, the sessions being performed over a period of two days. The sweetener compositions were added to 4 oz. hot FOLGERS instant coffee as above, and the panelists were asked to complete a similar questionnaire/ballot. The results are shown in the following Tables.

TABLE 6
Description of taste samples used for SAR #546

| Sample ID | Description | Amount Used |
|---|---|---|
| Aspartame | Dextrose with maltodextrin, aspartame | 1.0 g/6 oz coffee* |
| (EQUAL) | | |
| Sample C | Rebaudioside A (0.032 g) + non- | 4.0 g/6 oz coffee* |
| | congruent flavor volatile (0.0716) + | |
| | erythritol (3.968 g)† | |

*FOLGERS Instant coffee
n = 63
†Produced on a 10 lb scale, as opposed to small scale preparation as used in previous formulations.

TABLE 7
SAR #546 results

| Samples | Overall** | Flavor** | Bitterness*** | Aftertaste*** |
|---|---|---|---|---|
| (n = 63) | Liking | Liking | Intensity | Intensity |
| Asgartame | 6.52 | 6.48 | 12.90 | 11.79 |
| (EQUAL) | | | | |
| Sample B | 6.19 | 6.40 | 14.45 | 16.11 |

*Means followed with different letters are significantly different from each other at p < 0.05
**1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely
***0-100 scale; “barely detectable” = 1.4; “weak” = 6.1; “moderate” = 17.2; “strong” = 35.4; “very strong” = 53.3; “strongest imaginable” = 100

The results of the SAR #546 tasting session indicated that a sweetener composition containing Sample C scored about the same as aspartame in overall liking and flavor liking, scored only marginally higher than aspartame with respect to bitterness intensity, and scored slightly higher in aftertaste intensity.

### Example 4

### Home Use Test Involving HIS and Taste Modifying Composition

A consumer panel, home use taste test was performed comparing aspartame to a first sample (Sample C) containing a HIS (where the HIS is rebaudioside A), a bulking agent (where the bulking agent is erythritol) and, a taste modifying composition (where the taste modifying composition contains at least one non-congruent flavor volatile and a plurality of congruent flavor volatiles). The aspartame was an EQUAL-brand table-top formulation. The samples can be identified as listed in Table 8.

TABLE 8
Sample Identification

| Sample | Description | Code |
|---|---|---|
| Sample C | 4 g* Sample C packed | HUT Code: 315 |
| | in white paper sachets. | Plant Code: |
| | | T-C70801 |
| Equal | 1 g* bulk Equal tabletop | HUT Code: 780 |
| | sweetener packed in white | Plant Code: |
| | paper sachets. | T-C70802 |

*Sample C was average of 4.03 g, and Equal was average of 0.77 g in the sachets.

The screening criteria for the panelists included the following:

Male and female individuals, age 18-60+ (80% age 24-59), who regularly sweeten beverages such as coffee, tea and/or foods such as fruit, cereal with sugar or a sugar substitute a minimum of 2-3 times per week were recruited with an online survey.

The testing approach included the following:

Panelists were divided into two groups. Panelists in each group evaluated only one of the samples. One group consisting of 113 employees evaluated Sample C, and the other group consisting of 62 employees evaluated the Equal sample. A little more than half of the panelists (57%) had not previously tasted Sample C before participating the test.

Sample C and the Equal samples were handled as follows:

75 sachets of each sample were packed in 1-gallon zip-lock bags. The bags were labeled with a three-digit code, usage instructions, sample ingredients, and an allergen statement. The bags were mailed in confidential envelopes to the panelists. Panelists also received a paper copy of the questionnaire, usage instructions, and a pre-addressed envelope in their packets. Panelists were instructed to mail back used empty sachets as well as any unused sachets in the pre-addressed envelopes.

The panelists were asked to complete a questionnaire/ballot that used a standard 9-point hedonic scale involving: Bitterness/Sweetness JAR (Just About Right Scale), Bitterness/Aftertaste Intensity LMS (Labeled Magnitude Scale), and creamer usage. The data were analyzed by ANOVA using a SAS statistical program to determine significant differences in means between the samples. The results related to overall liking are shown in the following Tables.

In rating the “overall liking”, the consumer panelists were asked to rate the sample on a scale of 1-9, in which 1=dislike extremely, 2=dislike very much, 3=dislike moderately, 4=dislike slightly, 5=neither like nor dislike, 6=like slightly, 7=like moderately, 8=like very much, 9=like extremely. The data was analyzed by ANOVA with SAS statistical program for significant differences in means between the samples. Results and analyses are presented in Tables 8a-d.

Tables 8a-8d: Overall Liking in Coffee/Tea and on Fruit/Cereal:

TABLE 8a
Results in Coffee

| Liking | | | | |
|---|---|---|---|---|
| Attribute | Samples | n*** | Mean | |
| Overall Liking** | Sample C | 80 | 6.21 | a* |
| | Equal | 41 | 6.29 | a* |

TABLE 8b
Results in Tea

| Liking Attribute | Samples | n*** | Mean | |
|---|---|---|---|---|
| Overall Liking** | Sample C | 51 | 6.69 | a* |
| | Equal | 29 | 6.21 | a* |

TABLE 8c
Results on Fruit

| Liking Attribute | Samples | n*** | Mean | |
|---|---|---|---|---|
| Overall Liking** | Sample C | 48 | 6.54 | a* |
| | Equal | 23 | 7.09 | a* |

TABLE 8d
Results on Cereal

| Liking Attributes | Samples | n*** | Mean | |
|---|---|---|---|---|
| Overall Liking** | Sample C | 51 | 6.75 | a* |
| | Equal | 34 | 6.65 | a* |

*Means followed with different letters are significantly different from each other at p < 0.05.
**1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely.
***Number of employee panelists.

The results in Coffee/Tea and on Fruit/Cereal indicate that Sample C scored not statistically significantly different than Equal when used in coffee/tea, and topically on fruit/cereal.

Panelists were also instructed to open the package and look at the appearance of the sample to rate Appearance Liking before using the product. Results and analyses related to overall liking and specific attributes are presented in Tables 9a-9p.

TABLE 9a
Appearance Liking in the Package and on Fruit/Cereal

| Liking Attributes | Samples | n*** | Mean | |
|---|---|---|---|---|
| Appearance Liking** | Sample C | 113 | 6.70 | a* |
| | Equal | 62 | 6.08 | b* |

TABLE 9b
Results on Fruit

| Liking Attributes | Samples | n*** | Mean | |
|---|---|---|---|---|
| Appearance Liking** | Sample C | 48 | 6.88 | a* |
| | Equal | 23 | 6.83 | a* |

TABLE 9c
Results on Cereal

| Liking Attributes | Samples | n*** | Mean | |
|---|---|---|---|---|
| Appearance Liking** | Sample C | 51 | 6.86 | a* |
| | Equal | 34 | 6.00 | b* |

*Means followed with different letters are significantly different from each other at p < 0.05.
**1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely.
***Number of employee panelists.

The Appearance Liking Results indicate that Sample C crystalline appearance was statistically significantly more liked than Equal when evaluated in the package and on cereal. There was no significant difference between Sample C and Equal in Appearance Liking on Fruit.

TABLE 9d
Attributes Evaluated in the Package

| Liking Attributes | Samples | n | Mean | |
|---|---|---|---|---|
| Appearance Liking | Cobalt | 113 | 6.70 | a |
| | Equal | 62 | 6.08 | b |
| Aroma Liking | Cobalt | 113 | 6.80 | a |
| | Equal. | 62 | 5.94 | b |

1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely
Means followed with different letters are significantly different from each other at p < 0.05

Results show that Sample C was rated significantly higher in Appearance and Aroma Liking attributes than Equal when samples were evaluated in the package before adding to a beverage or food.

TABLE 9e
Attributes Evaluated in Coffee - Overall Liking

| Samples | n | Mean | |
|---|---|---|---|
| Sample C | 80 | 6.21 | a |
| Equal | 41 | 6.29 | a |

1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely
Means followed with different letters are significantly different from each other at p < 0.05

Results: There was no significant difference in Overall Liking between Sample C and Equal.

TABLE 9f
Attributes Evaluated in Coffee - Sweetness Just About Right (JAR)

| | | | Not Sweet | | |
|---|---|---|---|---|---|
| Samples | n | | Enough % | JAR % | Too Sweet % |
| Sample C | 80 | 3.24 a | 11.3 | 60 | 28.7* |
| Equal | 41 | 2.83 b | 36.6 | 41.5 | 21.9 |

1 = Not nearly sweet enough,
2 = Not quite sweet enough,
3 = Just about right,
4 = Somewhat too sweet,
5 = Much too sweet
Target JAR ≧ 75%
*A significant number of panelists rated this sample as “too sweet”
Means followed with different letters are significantly different from each other at p < 0.05

Results: A significant number of panelists rated Sample C as “too sweet”. Panelists rated Equal split between “too sweet” and “not sweet enough”.

TABLE 9g
Attributes Evaluated in Coffee - Bitterness
and Aftertaste Intensity Attributes

| Attribute | Samples | n | Means | |
|---|---|---|---|---|
| Bitterness | Sample C | 80 | 2.04 | a |
| | Equal | 41 | 2.12 | a |
| Aftertaste | Sample C | 80 | 2.48 | a |
| | Equal | 41 | 2.20 | a |

1 = none, 2 = weak, 3 = moderate, 4 = strong, 5 = very strong
Means followed with different letters are significantly different from each other at p < 0.05

Results: There were no significant differences in bitterness and aftertaste intensities between Sample C and Equal. Both samples were rated between “weak” to “moderate” in bitterness and aftertaste intensities.

TABLE 9h
Attributes Evaluated in Tea - Overall Liking

| Samples | n | Mean | |
|---|---|---|---|
| Sample C | 51 | 6.69 | a |
| Equal | 29 | 6.21 | a |

1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely
Means followed with different letters are significantly different from each other at p < 0.05

Results: There was no significant difference in Overall Liking between Cobalt and Equal.

TABLE 9i
Attributes Evaluated in Tea - Sweetness Just About Right (JAR)

| | | | Not Sweet | | |
|---|---|---|---|---|---|
| Samples | n | | Enough % | JAR % | Too Sweet % |
| Sample C | 51 | 3.10 a | 19.6 | 56.9 | 23.5 |
| Equal | 29 | 2.93 a | 24.1 | 55.2 | 20.7 |

1 = Not nearly sweet enough,
2 = Not quite sweet enough,
3 = Just about right,
4 = Somewhat too sweet,
5 = Much too sweet
Target JAR ≧ 75%
Means followed with different letters are significantly different from each other at p < 0.05

Results: Panelists rated both samples split between “too sweet” and “not sweet enough”.

TABLE 9j
Attributes Evaluated in Tea - Bitterness
and Aftertaste Intensity Attributes

| Attribute | Samples | n | Means | |
|---|---|---|---|---|
| Bitterness | Sample C | 51 | 1.90 | a |
| | Equal | 29 | 1.79 | a |
| Aftertaste | Sample C | 51 | 2.02 | a |
| | Equal | 29 | 2.14 | a |

1 = none, 2 = weak, 3 = moderate, 4 = strong, 5 = very strong
Means followed with different letters are significantly different from each other at p < 0.05

Results: There were no significant differences in bitterness and aftertaste intensities between Sample C and Equal. Both samples were rated about “weak” in bitterness and aftertaste intensities.

TABLE 9k
Attributes Evaluated on Fruit - Overall Liking

| Liking Attributes | Samples | n | Mean | |
|---|---|---|---|---|
| Appearance Liking | Sample C | 48 | 6.88 | a |
| | Equal | 23 | 6.83 | a |
| Aroma Liking | Sample C | 48 | 6.81 | a |
| | Equal | 23 | 5.87 | b |
| Overall Liking | Sample C | 48 | 6.54 | a |
| | Equal | 23 | 7.09 | a |

1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely
Means followed with different letters are significantly different from each other at p < 0.05

Results: There was no significant difference in Appearance and Overall Liking between Sample Cand Equal. Sample C was rated significantly higher in Aroma Liking than Equal.

TABLE 9l
Attributes Evaluated on Fruit - Sweetness Just About Right (JAR)

| | | | Not Sweet | | |
|---|---|---|---|---|---|
| Samples | n | | Enough % | JAR % | Too Sweet % |
| Sample C | 48 | 3.17 a | 14.6 | 58.3 | 27.1 |
| Equal | 23 | 3.09 a | 17.4 | 56.5 | 26.1 |

1 = Not nearly sweet enough,
2 = Not quite sweet enough,
3 = Just about right,
4 = Somewhat too sweet,
5 = Much too sweet
Target JAR ≧ 75%
*A significant number of panelists rated this sample as “too sweet”
Means followed with different letters are significantly different from each other at p < 0.05

Results: Panelists rated both samples split between “too sweet” and “not sweet enough”.

TABLE 9m
Attributes Evaluated on Fruit - Bitterness
and Aftertaste Intensity Attributes

| Attribute | Samples | n | Means | |
|---|---|---|---|---|
| Bitterness | Sample C | 48 | 1.71 | a |
| | Equal | 23 | 1.48 | a |
| Aftertaste | Sample C | 48 | 2.17 | a |
| | Equal | 23 | 1.74 | a |

1 = none, 2 = weak, 3 = moderate, 4 = strong, 5 = very strong
Means followed with different letters are significantly different from each other at p < 0.05

Results: There were no significant differences in bitterness and aftertaste intensities between Sample C and Equal. Both samples were rated about “weak” in bitterness and aftertaste intensities.

TABLE 9n
Attributes Evaluated on Cereal - Overall Liking

| Liking Attributes | Samples | n | Mean | |
|---|---|---|---|---|
| Appearance Liking | Sample C | 51 | 6.86 | a |
| | Equal | 34 | 6.00 | b |
| Aroma Liking | Sample C | 51 | 6.63 | a |
| | Equal | 34 | 5.91 | b |
| Overall Liking | Sample C | 51 | 6.75 | a |
| | Equal | 34 | 6.65 | a |

1 = Dislike extremely, 2 = Dislike very much, 3 = Dislike moderately, 4 = Dislike slightly, 5 = Neither like nor dislike, 6 = Like slightly, 7 = Like moderately, 8 = Like very much, 9 = Like extremely
Means followed with different letters are significantly different from each other at p < 0.05

Results: Sample C was rated significantly higher in Appearance and Aroma Liking than Equal. There was no significant difference in Overall Liking between Sample C and Equal.

TABLE 9o
Attributes Evaluated on Cereal - Sweetness Just About Right (JAR)

| | | | Not Sweet | | |
|---|---|---|---|---|---|
| Samples | n | | Enough % | JAR % | Too Sweet % |
| Sample C | 51 | 3.08 a | 17.6 | 60.8 | 21.5 |
| Equal | 34 | 2.88 a | 26.4 | 55.9 | 17.6 |

1 = Not nearly sweet enough,
2 = Not quite sweet enough,
3 = Just about right,
4 = Somewhat too sweet,
5 = Much too sweet
Target JAR ≧ 75%
*A significant number of panelists rated this sample as “too sweet”
Means followed with different letters are significantly different from each other at p < 0.05

Results: Panelists rated both samples split between “too sweet” and “not sweet enough”.

TABLE 9p
Attributes Evaluated on Cereal - Bitterness
and Aftertaste Intensity Attributes

| Attribute | Samples | n | Means | |
|---|---|---|---|---|
| Bitterness | Sample C | 51 | 1.69 | a |
| | Equal | 34 | 1.56 | a |
| Aftertaste | Sample C | 51 | 1.80 | a |
| | Equal | 34 | 2.03 | a |

1 = none, 2 = weak, 3 = moderate, 4 = strong, 5 = very strong
Means followed with different letters are significantly different from each other at p < 0.05

Results: There were no significant differences in bitterness and aftertaste intensities between Sample C and Equal. Both samples were rated about “weak” in bitterness and aftertaste intensities.

### Example 5

### Recipes

The sweetener of the present invention may be used for a variety of applications including uses in food, beverages, confections, and pharmaceuticals/over the counter drugs. The following are merely some representative recipes that utilize the sweetener of the present invention. For each of the recipes, the sweetener includes rebaudioside A, erythritol and a taste modifying composition of the present invention.

1. Tripleberry Soymilk Smoothie

2 cups low-fat vanilla soymilk

1 cup blackberries

1 cup strawberries

1 cup blueberries

⅛ teaspoon cinnamon

8 packets sweetener

2. Pineapple Orange Banana Frostie

1 cup nonfat plain yogurt

½ cup pineapple juice

1 banana

1 cup orange juice

1 cup ice

8 packets sweetener (4 g each)

3. Strawberry Banana Sunrise Smoothie

1 cup strawberries

1 banana

1 cup nonfat plain yogurt

1 cup orange juice

1 cup ice

8 packets sweetener (4 g each)

4. Banana Berry Smoothie

1 cup strawberries

1 cup blueberries

1 banana

1 cup fat free plain yogurt

1 cup orange juice

1 cup ice

4 packets sweetener (4 g each)

5. Pumpkin Pie

Ingredients:

Pastry for single-crust 9-inch pie

1 can (16 ounces) pumpkin

1 can (12 ounces) evaporated fat-free milk

3 eggs

20 packets (4 g each) of Sweetener

1 teaspoon vanilla

1½ teaspoon pumpkin spice

¼ tsp salt

Whipped topping, optional

Preparation:

Roll out pastry on floured surface to fit 1 inch past pie pan. Carefully place in pie pan, trim and flute edge. Mix pumpkin, milk, eggs on medium speed until well mixed. Add additional ingredients and mix well. Pour mixture into pie pan. Bake at 400 F for 35 to 40 minutes or until knife inserted into middle comes out clean. Cool on wire rack. Top with whipped topping, if desired.

6. Blueberry Pie

Ingredients:

Pastry for double-crust 9-inch pie

6 cups fresh blueberries or 2 (16 oz) packages frozen

3 tbsp lemon juice

¼ teaspoon ground cinnamon

6 tablespoons cornstarch

1 tablespoon butter

24 packets (4 g each) of Sweetener

Preparation:

Roll half of the out pastry on floured surface to fit 1 inch past pie pan. Carefully place in pie pan. Toss blueberries with lemon juice in large bowl. Add sweetener, cornstarch, cinnamon. Toss until coated. Pour blueberry mix into crust. Roll remaining pastry into circle large enough to cover pie. Place over blueberries, seal edges, trim and flute. Cut slits in top to allow steam to escape. Bake at 400 F for 55 to 60 minutes or until crust is golden. Cool on wire rack.

7. Apple Pie

Ingredients:

Pastry for double-crust 9-inch pie

8 cups Granny Smith apples, peeled, cored, and sliced

1 tbsp lemon zest

1 teaspoon ground cinnamon

¼ teaspoon ground nutmeg

¼ teaspoon salt

3 tablespoons cornstarch

1 tablespoon butter

24 packets (4 g each) of Sweetener

Preparation: Roll half of the out pastry on floured surface to fit 1 inch past pie pan. Carefully place in pie pan. Blend sweetener, cornstarch, salt, cinnamon and nutmeg in small bowl. Sprinkle on apples and toss until coated. Add lemon zest, mix thoroughly. Arrange apple mix into crust. Cut butter into slices, place on top of apples. Roll remaining pastry into circle large enough to cover pie. Place over apples, seal edges, trim and flute. Cut slits in top to allow steam to escape. Bake at 400 F for 40 to 50 minutes or until crust is golden. Cool on wire rack.

### Example 6

### Methods of Preparing the Sweetener

Blends and agglomerated blends of rebiana and of bulking material and Rebiana can be achieved through seven different processes.
a) Direct spray drying of pure or a blended material.
   i. This method can be used to produce a product that is 0-100 wt % rebiana mixed with bulking material. Based on the desired final concentration of Bulking material and Rebiana the appropriate amount of each component is dissolved in water in hot (60-85° C.) water to produce the spray solution. The solution is then spray dried to produce an amorphous product.
b) Direct spray drying and agglomeration of blended material in a fluidized spray dryer.
   i. The same process as above is used on a different piece of equipment that allows for the agglomeration of spray-dried material as it is produced.
c) Direct spray drying of blended material with post agglomeration.
   i. Material produced in process number one can be used in any of the following agglomeration processes. The only change would be the material in the bowl of the agglomerator would be a pre-blended amorphous material rather then pure ingredient.
d) Agglomeration of crystalline or amorphous Rebiana with bulking material utilizing a water and bulking material spray solution.
   i. This method can be used to produce a product that is 0-100% wt % rebiana mixed with bulking material. Based on the desired final concentration of Bulking material and Rebiana the appropriate amount of each component is placed in the bowl of a fluid bed agglomerator, 10% of the bulking material is reserved from the bowl and blended with water to produce the spray solution. The agglomeration begins with a water only spray to build the initial particle size. Once the particle has been built it is strengthened and “sealed” utilizing the bulking material spray solution. After the final spray step the material is dried to the appropriate moisture level.
e) Agglomeration of bulking material utilizing a Rebiana and water Spray solution.
   i. This method can be used to produce a product that is 0-20 wt % rebiana sprayed onto bulking material. Based on the desired final concentration of Bulking material and Rebiana the appropriate amount of Rebiana is dissolved in hot (60-85° C.) water to produce the spray solution. The agglomeration bowl is filled with bulking material only. The agglomeration begins with a water only spray to build the initial particle size. Once the particle has been built it is strengthened and “sealed” utilizing the rebiana spray solution. After the final spray step the material is dried to the appropriate moisture level.
f) Agglomeration of crystalline or amorphous Rebiana with a bulking material spray solution.
   i. This method can be used to produce a product that is 70-100 wt % Rebiana. Based on the desired final concentration of Bulking material and Rebiana the appropriate amount of Bulking material is dissolved in water to produce the spray solution. The agglomeration bowl is filled with Rebiana only. The agglomeration begins with a water only spray to build the initial particle size. Once the particle has been built it is strengthened and “sealed” utilizing the bulking material spray solution. After the final spray step the material is dried to the appropriate moisture level,
g) Agglomeration of crystalline or amorphous Rebiana with a water or water and Rebiana spray solution.
   i. This method can be used to produce a product that is 100 wt % Rebiana. If a Rebiana spray will be used, the appropriate amount of Rebiana is dissolved in hot (60-85° C.) water to produce the spray solution. The agglomeration bowl is filled with Rebiana only. The agglomeration begins with a water only spray to build the initial particle size. Once the particle has been built it is strengthened and “sealed” utilizing the Rebiana spray solution. After the final spray step the material is dried to the appropriate moisture level.

The list above is not intended to be exhaustive, any combination of the previously described methods or blends are applicable. The technology can also be applied to both batch and continuous systems. Also, the binder HPMC or gum arabic can serve as the spray solution, or as an additive to the previously mentioned spray solutions, to increase the particle strength and improve the particle size distribution.

These and other applications and implementations will be apparent in view of the disclosure. Such modifications, substitutions and alternatives can be made without departing from the spirit and scope of the invention, which should be determined from the appended claims.

What is claimed is:

1. A sweetener comprising a high intensity sweetener and a taste modifying composition, wherein the taste modifying composition comprises at least one non-congruent flavor volatile.

2. The sweetener of claim 1, wherein the taste modifying composition further comprises at least one congruent flavor volatile.

3. The sweetener of claim 1, wherein the high intensity sweetener has a sweet quality that is slower in onset and longer in duration than the sweet quality of sugar and wherein the at least one congruent flavor volatile and the at least one non-congruent flavor volatile modify the sweet quality of the high intensity sweetener such that the sweet quality intensity occurs earlier and the sweet quality diminishes earlier compared to a composition of the high intensity sweetener alone.

4. The sweetener of claim 1, wherein the at least one non-congruent flavor volatile is selected from the group consisting of alpha ionone, allyl alpha-ionone, cycloionone, dehydrodihydroionone, dihydro-alpha-ionone, dihydro-beta-ionone, dihydromethyl-alpha-ionone, dimethylionone, (E)-6,10-dimethylundeca-5,9-dien-2-one, gamma ionone, gamma-methyl ionone, ionone, alpha-ionone, β-ionone trans-beta-ionone, beta-ionone epoxide, gamma-ionone, alpha-irone, isobutylionone, alpha-isomethylionone, beta-isomethylionone, methylionone, methyl-alpha-ionone, alpha-methyl-ionone, methyl-beta-ionone, methyl-delta-ionone, methyl alpha-iononylglycidate, beta-methylionone diethyl ketal, methylisopseudoionone, pseudomethylionones, 3,4,5,6-tetrahydropseudoionone, pseudoionone raspberry essence, raspberry seed extract, jasmine absolute, boronia absolute and mixtures thereof.

5. The sweetener of claim 2, wherein the at least one congruent flavor volatile is selected from the group consisting of vanillin, vanilla extract, divanillin, ethyl vanillin, ethylvanillin acetate, ethylvanillin beta-d-glucopyranoside, ethylvanillin isobutyrate, ethylvanillin propylene glycol acetal, vanillin acetate, vanillin erythro and threo butan-2,3-dial acetal, vanillin isobutyrate, vanillin 3-(1-menthoxy)propane-1,2-diol acetal, vanillin propylene glycol acetal, veratraldehyde, 3-Ethyl-2-hydroxy-4-methylcyclopent-2-en-1-one, 5-Ethyl-2-hydroxy-3-methylcyclopent-2-en-1-one, methylcyclopentenolone, ethyl cyclopentenolone, ethyl maltol, maltol, maltol acetate, maltol butyrate, maltol isobutyrate, maltol propionate, sugar treattarone, sugar distallate, molasses distillate, malt distillate, 4-hydroxy-5-methyl-3(2H)furanone, 4-acetoxy-2,5-dimethyl-3 (2H)-furfanone, caramel furfanone, 4,5-dimethyl-3-hydroxy-2,5-dihydrofuranone (Sotolone), 4-hydroxy-2,5-dimethyl-3(2H)furanone (Strawberry Furanone), 2-ethyl-4-hydroxy-5-methyl-3(2H)furanone (Homofuronol), 5-methly furfural, 4-methyl-1-phenyl-2-pentanone, Isobutyl benzyl ketone, 2-Methyltetrandrofuran-3-one, coffee furanone, 2-Oxobutyric acid, maltone, valeraldehydes, butyraldehydes, phenyl compounds, such as phenyl acetaldehyde, beeswax absolute, honey distillate, and rum absolute, and mixtures thereof.

6. The sweetener of claim 1, wherein the high intensity sweetener is selected from the group consisting of rebaudioside A, rebaudioside B, rebaudioside C, rebaudioside D, rebaudioside E, rebaudioside F, dulcoside A, dulcoside B, rubusoside, stevia, stevioside, mogroside IV, mogroside V, Luo Han Quo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside 1, periandrin 1, abrusoside A, cyclocarioside 1, sodium saccharin, cyclamate, aspartame, acesulfame potassium, sucralose, alitame, neotame, neohesperidin dyhydrochalone (NHDC) and combinations thereof.

7. The sweetener of claim 6, wherein the high intensity sweetener is rebaudioside A.

8. The sweetener of claim 1, wherein the high intensity sweetener has a sweet quality having reduced initial intensity compared to sweet quality of sugar.

9. The sweetener of claim 1, wherein the weight ratio of the high intensity sweetener to the flavor composition is from about 0.0102:1 to about 286:1.

10. The sweetener of claim 1, wherein the weight ratio of the high intensity sweetener to the flavor composition is 14:1.

11. The sweetener of claim 1, further comprising a bulking material.

12. The sweetener of claim 11, wherein the weight ratio of the bulking material to the high intensity sweetener to the taste modifying composition is from about 225:1.8:1 to about 14370:115:1.

13. The sweetener of claim 11, wherein the bulking material as less than about 0.2 calories per gram of bulking agent.

14. The sweetener of claim 11, wherein the bulking material has a particle distribution size of from about 0.125 mm to about 1.0 mm.

15. The sweetener of claim 11, wherein the bulking material is selected from the group consisting of maltodextrin, corn syrup solids, sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, trehalose, isomaltulose, arabinogalactan, cellulose and cellulose derivatives, and mixtures thereof.

16. The sweetener of claim 11, wherein the high intensity sweetener and taste modifying composition are deposited on the bulking material.

17. The sweetener of claim 11, wherein the high intensity sweetener is deposited onto the bulking material before the taste modifying composition.

18. The sweetener of claim 11, wherein the high intensity sweetener, the bulking material and taste modifying composition are co-crystalized.

19. The sweetener of claim 11, wherein the sweetener is in the form of a crystal, a powder a tablet, a liquid, a cube, a glaze, a granulated product or combinations thereof

20. The sweetener of claim 19, wherein the crystal has a solubility profile comparable to sugar.

21. A tabletop sweetener comprising the sweetener composition of claim 1.

22. A tabletop sweetener comprising the composition of claim 11.

23. A food product comprising the composition of claim 1.

24. A pharmaceutical or over the counter drug product comprising the sweetener composition of claim 1.

25. A pharmaceutical or over the counter drug product comprising the composition of claim 11.

26. A beverage comprising the sweetener composition of claim 1.

27. A beverage comprising the composition of claim 11.

28. A method of making a tabletop sweetener comprising the step of depositing a high intensity sweetener and a taste modifying composition onto a bulking material having a particle size distribution of from about 0.125 mm to about 1.0 mm.

29. The method of claim 28, wherein the high intensity sweetener is deposited onto the bulking material before the taste modifying composition.

30. The method of claim 28, wherein the high intensity sweetener is deposited simultaneously onto the bulking material.

31. A method of making a tabletop sweetener comprising the steps of:
a. introducing a bulking material having a size distribution of from about 0.125 mm to about 1.0 mm into a vessel;
b. depositing a high intensity sweetener composition onto the bulking material;
c. depositing a taste modifying composition onto the bulking, material.

32. The method of claim 31, wherein the bulking material is fluidized by blowing air through the vessel such that the bulking material moves randomly throughout the vessel.

33. The method of claim 31, wherein the bulking material has a particle size distribution of from about 0.125 mm to about 1.0 mm.

34. The method of claim 31, wherein the bulking material is erythritol.

35. The method of claim 31, wherein the high intensity sweetener composition is in the form of a liquid.

36. The method of claim 31, wherein the high intensity sweetener composition is rebaudioside A.

37. The method of claim 31, wherein the taste modifying composition is in the form of a liquid.

38. The method of claim 31, wherein the taste modifying composition is deposited onto the bulking material and high intensity sweetener composition at ambient temperature conditions.

39. The method of claim 31, wherein the taste modifying composition is dried onto the bulking material and the high intensity sweetener composition with air at a temperature of from about 20 to about 130 degrees Celsius.

40. The method of claim 31, wherein the ratio of bulking material to high intensity sweetener composition to taste modifying composition is from about 225:1.8:1 to about 14370:115:1.
